(19) United States
(12) Patent Application Publication
(10) Pub. No.: US 2012/0086322 A1
(43) Pub. Date: Apr. 12, 2012

(54) LED BULB HEAT DISSIPATION STRUCTURE

(76) Inventors: Wen-Ji Lan, Sinjhuang City (TW); Xiao-Zhen Zeng, Sinjhuang City (TW)

(21) Appl. No.: 12/902,957

(22) Filed: Oct. 12, 2010

(51) Int. Cl. H01J 61/52

(52) U.S. Cl. 313/46

(57) ABSTRACT

An LED bulb heat dissipation structure includes a heat dissipation member and a heat conduction member. The heat dissipation member has a first main body, a heat dissipation section and an electrical conduction section. The heat dissipation section is arranged around the first main body and the electrical conduction section is disposed at one end of the first main body. The heat conduction member has a second main body upright protruding from the other end of the first main body. A heat conduction section is disposed along a periphery of the second main body. Multiple LED modules are disposed on the heat conduction section. The LED bulb heat dissipation structure is able to dissipate heat generated by the LED modules at higher heat dissipation efficiency and enlarge projection angle of the LED modules.

### FIELD OF THE INVENTION

The present invention relates to an LED bulb heat dissipation structure, and more particularly to an LED bulb heat dissipation structure, which is able to dissipate heat generated by LED modules at higher efficiency. In addition, with the LED bulb heat dissipation structure, the LED modules can emit light to provide 360-degree illumination.

### BACKGROUND OF THE INVENTION

It is known that LED has the advantages of long lifetime, power saving and small volume. Moreover, LED is free from mercury pollution and meets the requirement of environmental protection. Following the advance of chip packaging technology, the application range of LED has expanded from the field of indicator lamps to other usages such as illumination and panel backlight.

An LED chip is energized by electrical power to generate “light” and “heat”. As to the present technology, the ratio of light to heat is about 25%:75%.

The light and heat of LED have two major properties: First, LED emits light in a specific direction in the form of a semi-sphere. The projection angle of LED is about 20 degrees. Accordingly, the intensity of the straightforward light of LED is strongest, while the intensity of the lateral light is weaker. Second, too high temperature of LED will lead to light decay. Therefore, it is necessary to efficiently dissipate the heat to maintain the normal light flux.

There are two types of conventional LEDs. One is the lamp type point light source package (pin through hole) and the other is the SMD type point light source package (surface mount device). According to the drive current, the conventional LEDs can be also divided into high-power (operation current over 350 mA) high-brightness LED and low-power (operation current 20 mA˜100 mA) indicator LED. The high-power LED will emit strong light and generate high heat and is generally applied to a light bulb or a streetlight. The low-power LED will emit weak light and is generally applied to signal light or direction indicator light (such as traffic light or vehicle turn signal light).

The conventional LED bulbs adopt such point light source LEDs. The conventional LED bulbs have some shortcomings in common. For example, the conventional LED provides “indirect illumination” to lower the brightness of the bulb. Also, the huge “heat sink” limits the configuration and appearance of the bulb and increases the manufacturing cost. Moreover, in the case that multiple low-current LEDs are connected in series or in parallel, the circuit is complicated and has numerous contacts. This results in high failure ratio and poor stability of the conventional LED bulb. Therefore, the lifetime of the conventional LED bulb is shortened. In conclusion, the conventional LED bulb has the following defects:
1. The conventional LED bulb generally adopts the high-power LED (over 350 mA). The LED is covered by “an optical lens” and then attached to a heat sink. Then the LED is enclosed in a semi-spherical fogged shell. The light emitted from the LED is refracted by the “optical lens” to reach the fogged shell and then is refracted out of the shell. Such design of two-time refraction is for “indirect illumination”. The brightness will be partially lost during the refraction. Moreover, due to the limitation of the packaging method for the “point” light source and the “semi-spherical” shell, the lighting angle is smaller. Also, it is necessary to adopt “fogged-face” shell for creating the refraction and diffusion effect. In the case of “transparent” shell, it is impossible to create the refraction effect. Therefore, the conventional LED bulb is disadvantageous in that the type of shell is limited.
2. The high-power LED bulb will generate high heat and needs a large-size heat sink to help in dissipating the heat. This affects the configuration and appearance of the bulb. The heat is dissipated in such a manner that a “heat conduction paste” is applied to a lower side of the LED and then the LED is fixedly attached onto the heat sink. The heat sink is made of aluminum-zinc alloy by casting or aluminum extrusion lathe. The “heat conduction paste” itself is a kind of silicone with poor heat conductivity. Therefore, the heat conduction past can only provide limited heat dissipation effect. Moreover, the heat sink made of alloy by casting or
3. Inherently, the low-power “indicator LED” are not designed not illumination. Accordingly, the LED bulb composed of the low-power LEDs is generally packaged with epoxy, which can hardly isolate the LEDs from ultraviolet ray. As a result, such LED bulb is likely to age and is not durable to high temperature. Moreover, it is hard to dissipate the heat generated by the LEDs so that brightness decay will take place to lead to insufficient brightness. Furthermore, in the case that several tens or over one hundred of LEDs are connected in series or in parallel, the circuit is complicated and has numerous contacts. This results in higher failure ratio and poorer stability.

### SUMMARY OF THE INVENTION

A primary object of the present invention is to provide an LED bulb heat dissipation structure, which is able to dissipate heat generated by LED modules at higher efficiency. In addition, with the LED bulb heat dissipation structure, the LED modules can emit light to provide 360-degree illumination. To achieve the above and other objects, the LED bulb heat dissipation structure of the present invention includes a heat dissipation member and a heat conduction member. The heat dissipation member has a first main body, a heat dissipation section and an electrical conduction section. The heat dissipation section is arranged around the first main body and the electrical conduction section is disposed at one end of the first main body. The heat conduction member has a second main body, a heat conduction section and a heat conduction end. The second main body upright protrudes from the other end of the first main body opposite to the electrical conduction section. The heat conduction end is connected with the first main body. The heat conduction section is disposed along a periphery of the second main body. Multiple LED modules are disposed on the heat conduction section.

The LED bulb heat dissipation structure is able to dissipate heat generated by the LED modules at higher heat dissipation efficiency and enlarge projection angle of the LED modules. Accordingly, the present invention has the following advantages:

1. The LED modules can emit light to provide nearly 360-degree illumination.
2. Very good heat dissipation efficiency.

### BRIEF DESCRIPTION OF THE DRAWINGS

The structure and the technical means adopted by the present invention to achieve the above and other objects can be best understood by referring to the following detailed description of the preferred embodiments and the accompanying drawings, wherein:

FIG. 1 is a perspective exploded view of the present invention;

FIG. 2 is a perspective assembled view of the present invention; and

FIG. 3 shows the use of the present invention.

### DETAILED DESCRIPTION OF THE PREFERRED EMBODIMENTS

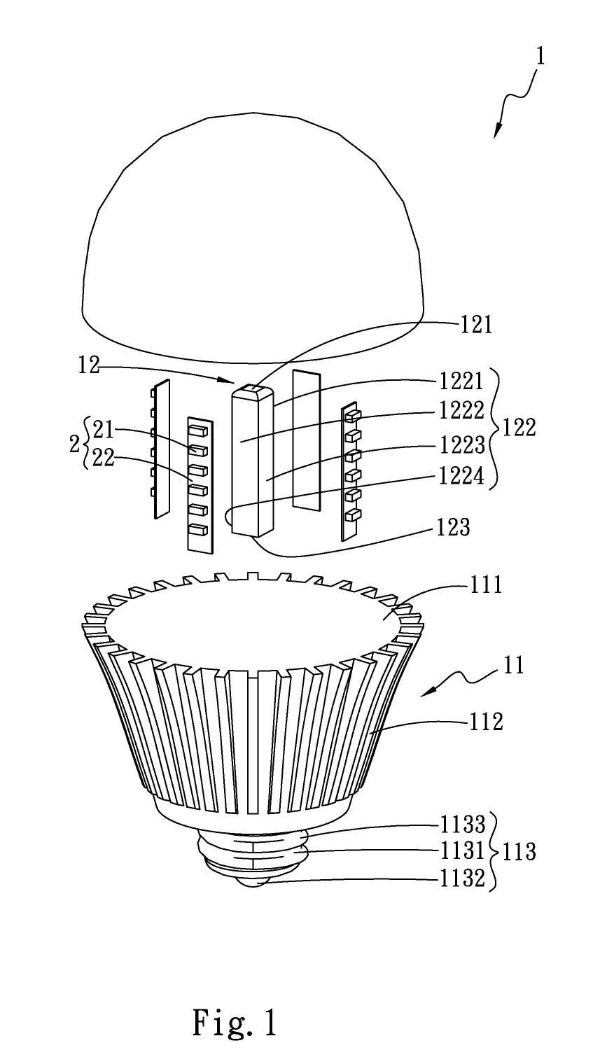

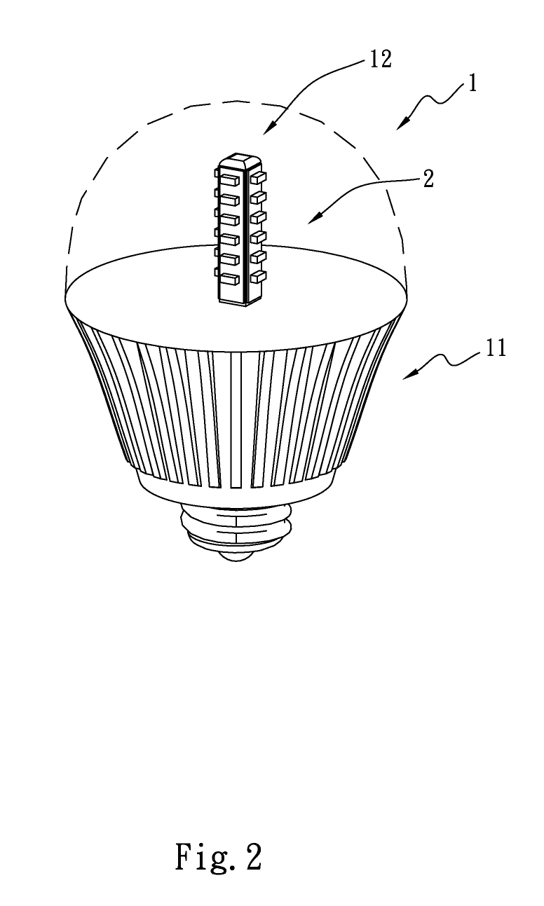

Please refer to FIGS. 1 and 2. FIG. 1 is a perspective exploded view of the present invention and FIG. 2 is a perspective assembled view of the present invention. The LED bulb heat dissipation structure 1 of the present invention includes a heat dissipation member 11 and a heat conduction member 12.

The heat dissipation member 11 has a first main body 111, a heat dissipation section 112 and an electrical conduction section 113. The heat dissipation section 112 is arranged around the first main body 111 and the electrical conduction section 113 is disposed at one end of the first main body 111.

The heat dissipation section 112 has the form of radiating fins or pin fins. In this embodiment, the heat dissipation section 112 includes, but not limited to, multiple radiating fins.

The electrical conduction section 113 is connected with the heat dissipation section 112. The electrical conduction section 113 has a conductive face 1131 and a conductive terminal 1132. The conductive face 1131 is formed with multiple threads 1133.

The heat conduction member 12 has a second main body 121, a heat conduction section 122 and a heat conduction end 123. The second main body 121 upright protrudes from the other end of the first main body 111 opposite to the electrical conduction section 113. The heat conduction end 123 is disposed at one end of the second main body 121 and connected with the first main body 111. The heat conduction section 122 is disposed along the periphery of the second main body 121. Multiple LED modules 2 are arranged on the heat conduction section 122.

The heat conduction section 122 has a first heat conduction face 1221, a second heat conduction face 1222, a third heat conduction face 1223 and a fourth heat conduction face 1224. At least one LED module 2 is arranged on each of the first, second, third and fourth heat conduction faces 1221, 1222, 1223, 1224. The LED module 2 has at least one LED bulb 21 and a substrate 22. The LED bulb 21 is positioned on one side of the substrate 22. The substrate 22 is attached to the heat conduction section 122.

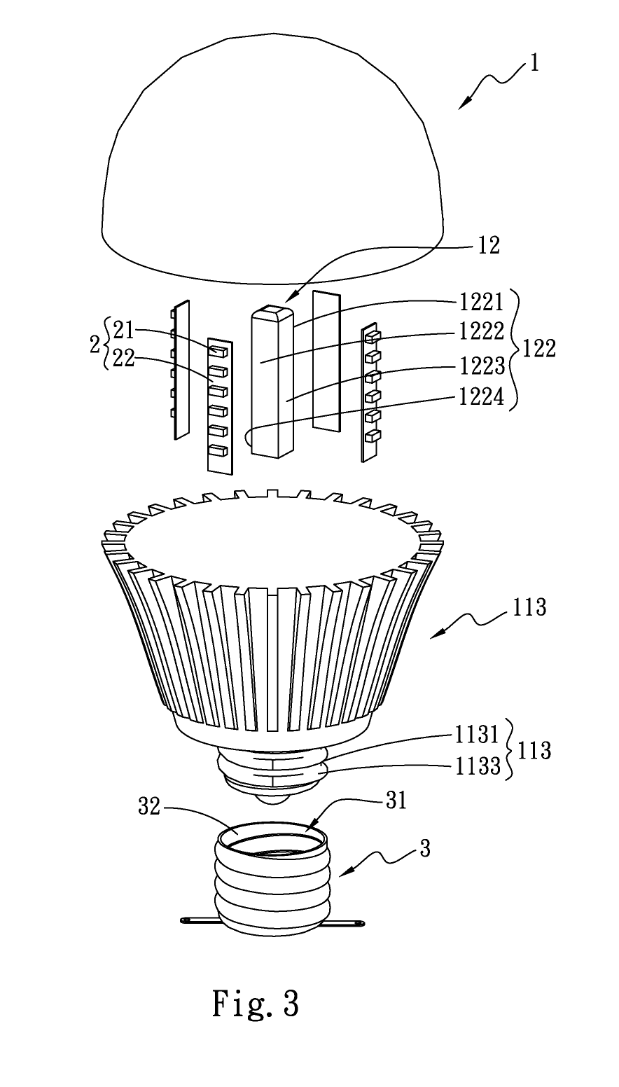

Please refer to FIG. 3, which shows the use of the present invention. In use of the LED bulb heat dissipation structure 1 of the present invention, the electrical conduction section 113 of the heat dissipation member 11 is screwed into a corresponding socket 3. The socket 3 has an opening 31 formed with multiple inner threads 32. The threads 1133 of the electrical conduction face 1131 are correspondingly screwed into the inner threads 32 of the socket 3 to affix the heat dissipation member 11 in the socket 3. The power is transmitted to the electrical conduction section 113 via the socket 3 and then the electrical conduction section 113 supplies the power to the LED modules 2. When the LED module 2 emits light, the LED module will generate heat. The heat conduction member 12 will transfer the heat of the LED module 2 to the heat dissipation member 11. The heat dissipation section 112 of the heat dissipation member 11 then dissipates the heat in the form of radiation.

As aforesaid, the LED modules 2 are arranged on the heat conduction section 122 of the heat conduction member 12 and the heat conduction member 12 is upright connected with the heat dissipation member 11. Also, the LED modules 2 are arranged on the first, second, third and fourth heat conduction faces 1221, 1222, 1223, 1224 of the heat conduction section 122 to provide wide-angle illumination effect.

The above embodiments are only used to illustrate the present invention, not intended to limit the scope thereof. It is understood that many changes and modifications of the above embodiments can be made without departing from the spirit of the present invention. The scope of the present invention is limited only by the appended claims.

What is claimed is:

1. An LED bulb heat dissipation structure comprising:
a heat dissipation member having a first main body, a heat dissipation section and an electrical conduction section, the heat dissipation section being arranged around the first main body and the electrical conduction section being disposed at one end of the first main body; and
a heat conduction member having a second main body, a heat conduction section and a heat conduction end, the second main body upright protruding from the other end of the first main body opposite to the electrical conduction section, the heat conduction end being connected with the first main body, the heat conduction section being disposed along a periphery of the second main body, at least one LED module being disposed on the heat conduction section.

2. The LED bulb heat dissipation structure as claimed in claim 1, wherein the heat dissipation section has the form of radiating fins or pin fins.

3. The LED bulb heat dissipation structure as claimed in claim 1, wherein the electrical conduction section has a conductive face and a conductive terminal, the conductive face being connected with the conductive terminal, the conductive face being formed with multiple threads.

4. The LED bulb heat dissipation structure as claimed in claim 1, wherein the heat conduction section has a first heat conduction face, a second heat conduction face, a third heat conduction face and a fourth heat conduction face, at least one LED module being arranged on each of the first, second, third and fourth heat conduction faces.

5. The LED bulb heat dissipation structure as claimed in claim 1, wherein the LED module has at least one LED bulb and a substrate.

6. The LED bulb heat dissipation structure as claimed in claim 4, wherein the LED module has at least one LED bulb and a substrate.
